(19) United States
(12) Patent Application Publication
(10) Pub. No.: US 2016/0180179 A1
(43) Pub. Date: Jun. 23, 2016

(54) VEHICLE PERIPHERY MONITORING APPARATUS AND PROGRAM

(71) Applicant: DENSO CORPORATION, Aichi (JP)

(72) Inventors: Nobuyuki Yokota, Kariya-city (JP); Muneaki Matsumoto, Kariya-city (JP)

(21) Appl. No.: 14/906,838

(22) PCT Filed: Jul. 16, 2014
(86) PCT No.: PCT/JP2014/003769

§ 371 Date: Jan. 21, 2016

(30) Foreign Application Priority Data
Jul. 26, 2013 (JP) 2013-155662

(51) Int. Cl. G06K 9/00; B60R 11/04; H04N 5/225; G06T 7/00; G06T 3/20; G06K 9/52; G06T 7/60; G06K 9/46; B60R 1/00; H04N 5/232

(52) U.S. Cl. CPC G06K 9/00798; B60R 1/00; B60R 11/04; H04N 5/2251; H04N 5/23293; G06T 3/20; G06K 9/52; G06T 7/60; G06K 9/4604; G06T 7/0085; G06T 7/0042; G06T 7/0081; G06T 2207/20112; G06K 2009/4666; G06T 2207/30252

(57) ABSTRACT

A vehicle periphery monitoring apparatus includes an image portion, an image processing portion, and a display portion. The image portion is mounted to a host vehicle and images a periphery including a road surface. The image processing portion subjects an original image to an image correction including a coordinate transformation by use of a parameter, causing a ratio of three segment areas of the original image to become close to a predetermined target ratio, and generates a virtual coordinate transformed image based on the original image. An end edge position of the host vehicle and a horizontal line position of the host vehicle are calculated from the parameter, and the original image is vertically segmented at the end edge position and the horizontal line position into the three segment areas. The display portion displays an image screen on a display area in a vehicle compartment.

### CROSS-REFERENCE TO RELATED APPLICATIONS

This application is based on Japanese Patent Application No. 2013-155662 A filed on Jul. 26, 2013, the disclosure of which is incorporated herein by reference.

### TECHNICAL FIELD

The present disclosure relates to a vehicle periphery monitoring apparatus and a program that image the periphery including at least one of forward and rearward directions of a host vehicle and display the image in the vehicle compartment to permit a driver to monitor a road condition from the vehicle compartment.

### BACKGROUND ART

Conventionally, a vehicle periphery monitoring apparatus is installed to mount a back camera to the rear of a vehicle, and processes an original image of the rear of the vehicle, the original image being captured by the back camera, to generate a virtual bird's-eye view image and display the bird's-eye view image on a display provided in the vehicle compartment.

In the vehicle periphery monitoring apparatus, a coordinate transformation from an original image to a bird's eye view image is performed using external parameters indicating a positional orientation of the back camera. In this case, when the positional orientation of the back camera is changed by a mounting error of the back camera or by a rocking of the vehicle, the coordinate transformation may be affected to generate an bird's-eye view image incorrectly. Therefore, a bumper position of a vehicle may be detected from an original image, and based on the detected bumper position, a mounting angle of a back camera may be calculated to correct external parameters (see Patent literature 1).

The inventors of the present application have found the following regarding a vehicle periphery monitoring apparatus. In a conventional vehicle periphery monitoring apparatus, only a condition of a road surface may be displayed on a display in a vehicle compartment as a bird's-eye view image. In this case, it may be difficult for a vehicle driver to acquire a positional relationship between a vehicle and the road surface from a bird's-eye view and acquire information about a height direction from a bird's-eye view. Therefore, the vehicle driver may feel discomfort and oppression.

### PRIOR ART DOCUMENT

### Patent Document

Patent literature 1: JP 2004-64441A

### SUMMARY OF THE INVENTION

It is an object of the present disclosure is to provide a vehicle periphery monitoring apparatus and a program that are capable of reducing discomfort and oppression of a vehicle driver when an image is displayed in a vehicle compartment.

According to one example of the present disclosure, a vehicle periphery monitoring apparatus includes an image portion, an image processing portion, and a display portion. The image portion is mounted to a host vehicle and images a periphery including a road surface of at least one of a forward direction and a rearward direction of the host vehicle. The image processing portion subjects an original image captured by the image portion to an image correction including a predetermined coordinate transformation by use of a parameter from which an end edge position of the host vehicle and a horizontal line position to the host vehicle are calculated, causing a ratio of three segment areas to become close to a predetermined target ratio, the original image being vertically segmented at the end edge position and the horizontal line position into the three segment areas, and generates a virtual coordinate transformed image based on the original image. The display portion displays an image screen based on the coordinate transformed image generated by the image processing portion on a predetermined display area in a vehicle compartment.

According to another example of the present disclosure, a program is provided to function a computer connected to the image portion and display portion as the image processing portion.

According to the vehicle periphery monitoring apparatus and the program of the present disclosure, when the three segment areas in the coordinate transformed image respectively include an edge area below the end edge position, a road surface area between the end edge position and a horizontal line position, and a sky area above the horizontal line position, it may be possible to display the image screen having the edge area, road surface area, and sky area that are balanced by a predetermined ratio.

According to the vehicle periphery monitoring apparatus and the program of the present disclosure, a vehicle driver can easily acquire not only the road condition but also the end edge position of the host vehicle and the horizontal line position relative to the host vehicle on the display in the vehicle compartment. It may be possible that the vehicle driver instinctively acquires a positional relationship between the host vehicle and road surface and information about the height direction according to the coordinate transformed image.

According the present disclosure, it may be possible to reduce the discomfort when the positional relationship between the host vehicle and road surface is not instinctively acquired from the display image in the vehicle compartment and the oppression when information about a position higher than the road surface is not acquired from the display image in the vehicle compartment, the discomfort and oppression being felt by the vehicle driver.

The parameters include an external parameter indicating a positional orientation of the image portion. According to a shape of a vehicle (also referred to as a host vehicle) having the image portion, the image processing portion performs a camera calibration using the parameters, and it may be possible to calculate the end edge position of the host vehicle and the horizontal line position relative to the host vehicle in advance. Thus, when the image portion is mounted to a different type (a model) of vehicle, it may be possible to calculate information about an end edge position of a host vehicle and a horizontal line position relative to a host vehicle in advance.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating an entire configuration of a vehicle periphery monitoring apparatus;

FIG. 2 is a diagram illustrating a mode of mounting a camera to a host vehicle;

FIG. 3 is a diagram illustrating each segment area in an image;

FIG. 4 is a flowchart illustrating contents of image processing performed by the vehicle periphery monitoring apparatus;

FIG. 5A is a diagram illustrating a composition of a simulation image (a bumper image) in the image processing; and

FIG. 5B is a diagram illustrating a composition of a simulation image (a sky image) in the image processing.

### PREFERRED EMBODIMENTS FOR CARRYING OUT THE INVENTION

Embodiments of the present disclosure will be described in reference to the drawings.

Incidentally, the present disclosure is not limited to the following embodiments. A mode in which part of the following embodiments is omitted is also an embodiment of the present disclosure as long as issues are soluble. Any modes that is considered without departing from the essence of the present disclosure are included in embodiments of the present disclosure. The reference numerals used in the explanation of the following embodiments are used for easy understanding of the present disclosure, and the reference numerals are not intended to limit the technical range of the present disclosure.

<Entire Configuration>

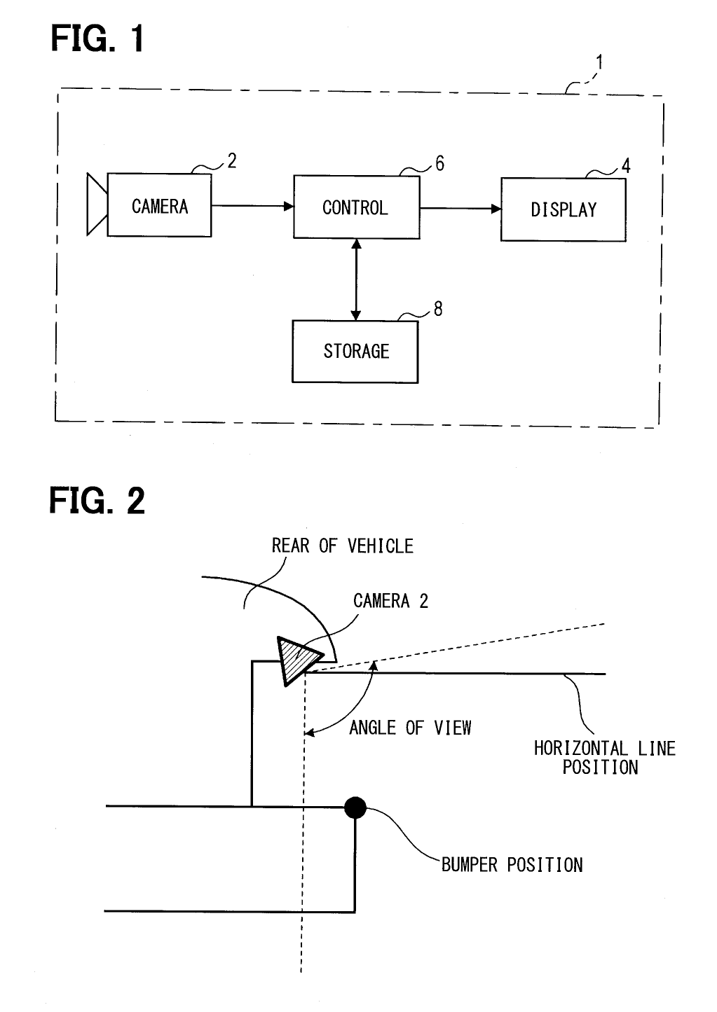

As shown in FIG. 1, a vehicle periphery monitoring apparatus 1 of the present embodiment includes a camera 2, a display portion 4, a control portion, a storage portion 8, or the like. The camera 2 is mounted to a vehicle and images the periphery including a road surface in at least one of forward and rearward directions of the vehicle (hereinafter, referred to as a host vehicle). The display portion 4 displays an image on a predetermined area in a compartment of the host vehicle. The control portion 6 performs an image correction (hereinafter, referred to as an image processing) including a predetermined coordinate transformation. The storage portion 8 stores various information items.

The camera 2 corresponds to an example of an image portion (or means) of the present disclosure. The display portion 4 corresponds to an example of a display portion (or means). The control portion 6 corresponds to an example of an image processing portion (or means).

The control portion 6 is a known electronic control apparatus including a microcomputer. The control portion 6 controls each portion of the vehicle periphery monitoring apparatus 1. The control portion 6 may be dedicated for a control of the vehicle periphery monitoring apparatus 1 or may be multipurpose to perform controls of other than the vehicle periphery monitoring apparatus 1. The control portion 6 may be provided alone or multiple control portions 6 may function together.

The camera 2 uses multiple fish-eye lenses installed to the rear of the host vehicle, and can widely image a road surface behind the host vehicle, a bumper as a rear edge portion of the host vehicle, and the vehicle periphery including a higher view than the road surface. The camera 2 has a control unit. When receiving an instruction about a cutout angle of view by the control portion 6, the camera 2 cuts out a part of an original image at the angle of view and supplies the cut-out image. In the present embodiment, the control portion 6 instructs the camera 2 to cut out a less-distorted, central part of the original image. The camera 2 provides the control portion 6 with an image (hereinafter, referred to as a camera image) of the central part that is cut out from the original image in response to the instruction.

The display portion 4 is a center display installed to or near a dashboard in the vehicle compartment of the host vehicle. The center display displays an image screen based on an image generated by performing the image processing for the camera image acquired by the control portion 6 from the camera 2.

The storage portion 8 is a non-volatile memory storing a program that defines the image processing performed by the control portion 6, an internal parameter (that is, a focal length of a lens, angle of view, and the number of pixels) specific to the camera 2, and an external parameter (hereinafter, referred to as a mounting parameter for the camera 2) indicating a positional orientation of the camera 2 in the world coordinate system. The storage portion 8 stores the information (hereinafter, referred to as bumper position-horizontal line position information) indicating a bumper position of the host vehicle and a horizontal line position relative to the host vehicle in the original image.

The horizontal line position mainly indicates a boundary between the sky and the ground in the original image captured by the camera 2. The bumper position mainly indicates a boundary between the ground and the host vehicle in the original image captured by the camera 2.

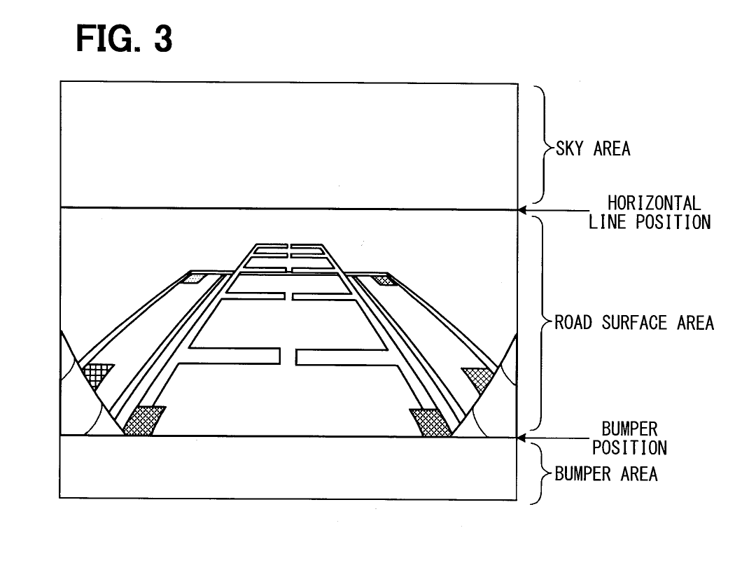

The bumper position-horizontal line position information includes the bumper position information and the horizontal line position. In detail, as in FIG. 2, the bumper position information indicates, as a coordinate, where each point forming the end edge position (a bumper position) viewed from the camera 2 is projected in the original image, the end edge being an edge (extending in a vehicle width direction) positioned at the end of the bumper of the rear of the vehicle. Additionally, the horizontal line position information indicates, as a coordinate, where a position (a horizontal line position) indicating the horizontal direction viewed from the camera 2 is projected in the original image.

The mounting parameter of the camera 2 includes position information that indicates a mounting position of the camera 2 as three dimensions (X, Y, and Z) relative to the host vehicle in the world coordinate system and also includes angle information that indicates a mounting angle of the camera 2 as a roll, pitch, and yaw. The control portion 6 (or the control apparatus of the camera 2) enables to calculate the bumper position-horizontal line position information by performing a camera calibration by use of the mounting parameter (and the internal parameter) of the camera 2 in advance.

The bumper position-horizontal line position information (additionally, the mounting parameter of the camera 2) can be calculated based on a shape of the vehicle (the host vehicle) mounting the camera 2 in advance. Even in the host vehicle of a different type (a different model), it may be possible to calculate the bumper position of the host vehicle and the horizontal line position relative to the host vehicle in the original image in advance.

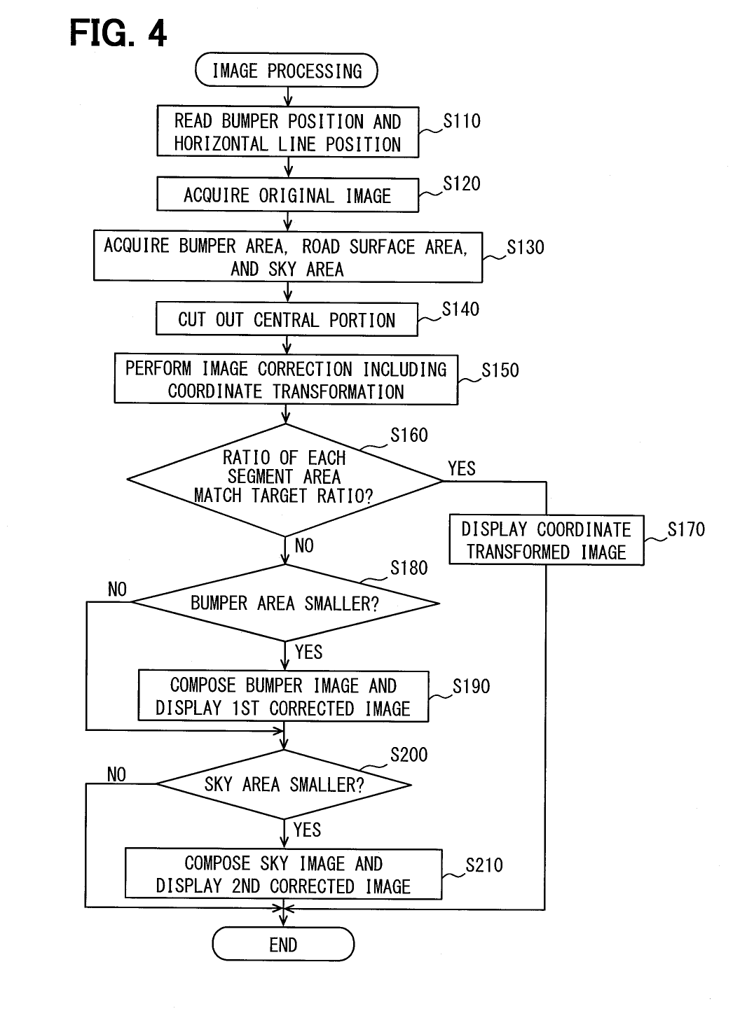

As shown in FIG. 3, in the original image (or the camera image) acquirable from the camera 2 and the image (a coordinate transformed image or a corrected image that are mentioned later) generated by image processing of the control portion 6, the area below the bumper position is called a bumper area (also referred to as an edge area) since the area mainly indicates the bumper of the rear of the vehicle. Similarly, an area between the bumper position and the horizontal line position is called a road surface area since the area mainly indicates a road surface condition. An area above the horizontal line position is called a sky area since the area mainly indicates the sky when no obstacle is present.

<Image Processing>

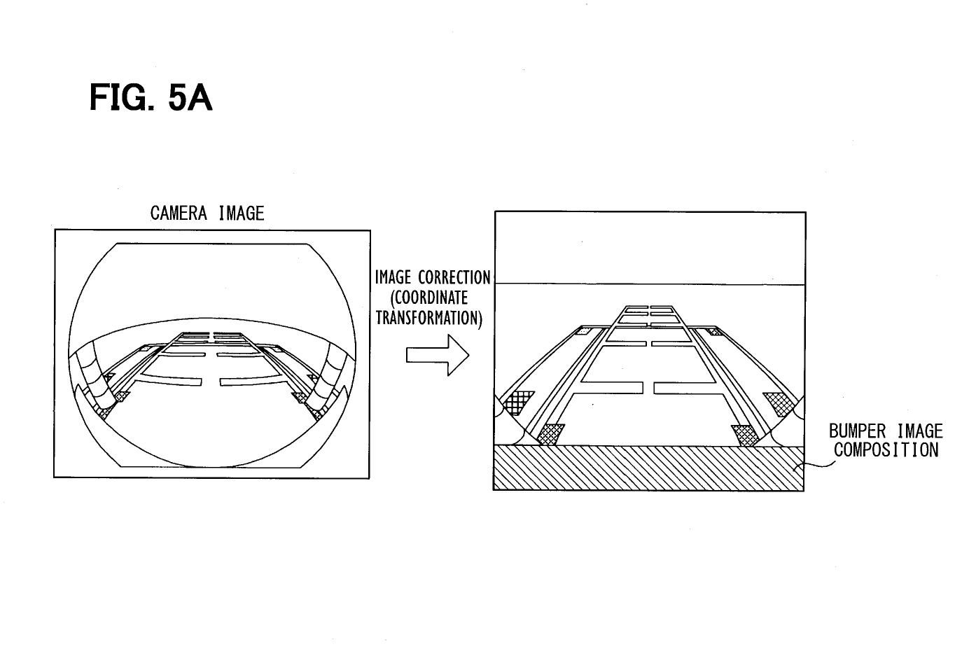

The image processing performed by the control portion 6 will be explained in reference to the flowchart of FIG. 4. This processing is started when, for example, an engine starts, a shift range is detected based on detection information provided from a shift position sensor (not shown), and the shift range is shifted to R. The control portion 6 performs this processing based on the program stored in the storage portion 8.

When this processing is started, the control portion 6 reads the bumper position-horizontal line position information from the storage portion 8 at S110, and acquires an original image from the camera 2 at S120.

At S130, based on the bumper position-horizontal line position information read at S110 and the original image acquired at S120, a group of coordinates (a group of multiple coordinates) respectively indicating three segment areas (the bumper area, the road surface area, and the sky area) into which the original image is vertically segmented at the bumper position and the horizontal line position is identified.

At S140, based on the original image acquired at S120, the camera 2 is instructed to cut out a less-distorted, central portion from the original image. When the camera 2 receives the instruction from the control portion 6, the camera 2 provides the camera image to the control portion 6.

At S150, based on the camera image acquired from the camera 2 at S140 and the coordinate group that indicate the three segment areas identified at S130, the camera image is subjected to an image correction including a predetermined coordinate transformation so as to make a ratio of each of the segment areas be close to predetermined target ratio and to generate a virtual coordinate transformed image based on the original image acquired at S110. In the present embodiment, the image correction is performed such that the sizes of at least the bumper area and the sky area in the camera image approach the sizes based on the target ratio without exceeding the sizes based on the target ratio.

Incidentally, the target ratio may be predetermined by a sensor evaluation to achieve a visual balance of the segment areas (the bumper area, the road surface area, the sky area) in the coordinate transformed image (and a corrected image). In the coordinate transformation, by use of the mounting parameter (position information and angle information regarding the mounting of the camera 2), a known viewport transformation is performed to transform an actual view of the camera 2 to a bird's eye view for easy recognition of a road condition. In the image correction, an aspect ratio of the image is changed as needed, in addition to the viewpoint transformation.

At S160, it is determined whether the ratio of the segment areas in the coordinate transformed image generated at S150 is equal to the target ratio. When an affirmative determination is made, the flowchart shifts to S170. When a negative determination is made, the flowchart shifts to S180.

At S170, an image screen based on the coordinate transformed image determined at S160 having the equal ratio of each of the segment areas to the target ratio is permitted to be displayed on the display portion 4, and this processing ends.

When the ratio of the three segment areas in the coordinate transformed image is equal to the target ratio (S160: YES), the image processing portion 6 permits the display portion 4 to display the image screen (S170).

At S180, in the coordinate transformed image determined to have the unequal ratio of each segment area to the target ratio at S160, it is determined whether the bumper area is smaller (than the size based on the target ratio). When the bumper area is smaller, the flowchart proceeds to S190. When a negative determination is made at S180, that is, when the size of the bumper area has the size based on the target ratio, the sky area is smaller (than the size based on the target ratio), and the flowchart proceeds to S210.

At S190, regarding the coordinate transformed image generated at

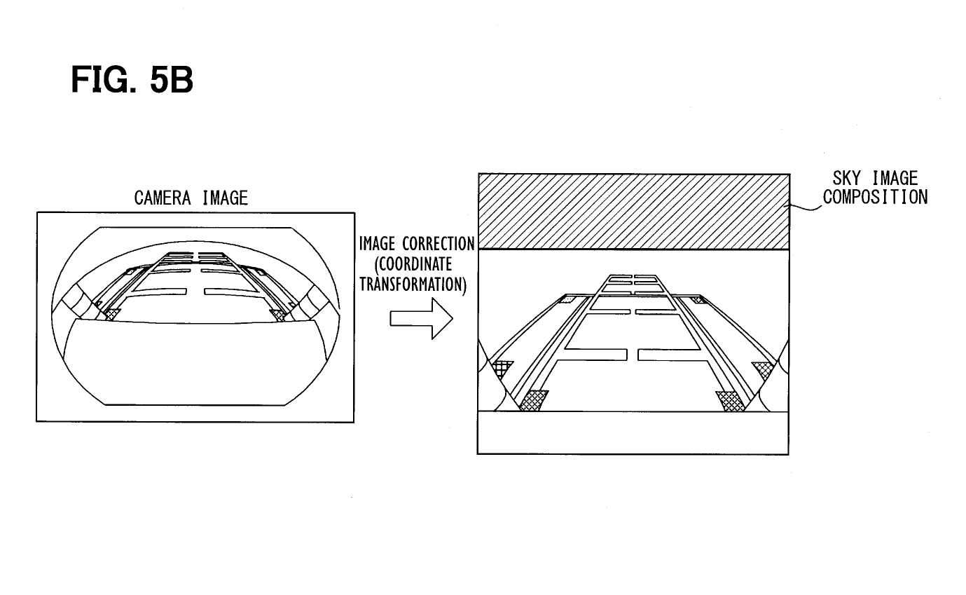

S150, an image (the bumper image) simulating the rear edge portion (the bumper) of the host vehicle is combined with at least part of the bumper area (see FIG. 5A) so as to approximate the bumper area to the size based on the target ratio. The image screen based on the image (hereinafter, a first corrected image) generated by combining the bumper image with the coordinate transformed image is permitted to be displayed on the display portion 4, and this processing ends. In this composition processing, an area lacking to reach the size based on the target ratio in the bumper area may be added to a bumper image sized to the lacking bumper area, or a bumper image sized to the entire bumper area based on the target ratio may be added to the entire bumper area. The bumper image may be any image that simulates the rear edge portion (the bumper) of the host vehicle, such as an image filled by blackish color as a simple one. The rear edge portion of the host vehicle corresponds to the bumper, for example.

At S200, in the coordinate transformed image determined that the ratio of the segment areas is unequal to the target ratio at S160, it is determined whether the sky area is smaller (than the size based on the target ratio). When the sky area is smaller, the flowchart proceeds to S210. When an affirmative determination is made, that is, when the sky area has the size based on the target ratio, this processing ends.

At S210, to make the sky area have the size based on the target ratio in the coordinate transformed image (or the first corrected image generated at S190) generated at S150, an image (the sky image) simulating a landscape of the sky is composed with at least part of the sky area (see FIG. 5B). The image screen based on the image (a second corrected image) generated by composing the sky image with the coordinate transformed image (or the first corrected image) is permitted to be displayed on the display portion 4, and this processing ends. In this composition processing, a sky image corresponding to a size reach the size based on the target ratio may be added to a sky image sized to the lacking area, or a sky image sized to the entire sky area based on the target ratio may be added to the entire sky area. The sky image may be any image simulating the sky, such as an image filled with bluish color as a simple one.

<Effect>

The vehicle periphery monitoring apparatus 1 includes the camera 2, the control portion 6, and the display portion 4. The camera 2 is mounted to the host vehicle to image the vehicle periphery including the road surface behind the host vehicle. The display portion 4 displays the image screen (including the image screen based on the corrected image) based on the coordinate transformed image generated by the control portion 6 on the predetermined display area in the vehicle compartment.

The control portion uses the mounting parameter of the camera 2 to calculate the end edge position (the bumper position) of the host vehicle and the horizontal line position relative to the host vehicle. The control portion subjects the original image captured by the camera 2 to the image correction including the predetermined coordinate transformation so as to approximate, to the predetermined target ratio, the ratio of the three segment areas into which the original image is vertically segmented at the bumper position and the horizontal line position. The virtual coordinate transformed image is generated.

According to this configuration, the three segment areas in the coordinate transformed image include the bumper area below the bumper position, the road surface area between the end edge position and the horizontal line position, and the sky area above the horizontal line position, respectively. It may be possible to display the image screen in which the bumper area, the road surface area, and the sky area are balanced at the predetermined ratio.

Therefore, it may be possible for the vehicle periphery monitoring apparatus 1 to indicate, to the vehicle driver, not only the road surface condition but also the bumper position of the host vehicle and the horizontal line position relative to the host vehicle as the coordinate transformed image on the display portion 4 in the vehicle compartment. According to this coordinate transformed image, it may be possible to cause the vehicle driver to intuitively recognize the positional relationship between the host vehicle and road surface and information about the height direction.

Therefore, according to the vehicle periphery monitoring apparatus 1, it may be possible to reduce the discomfort and oppression felt by the vehicle driver, and indicate a plain, good-looking image screen to the vehicle driver as the display image in the vehicle compartment. The discomfort is felt when the relationship between the host vehicle and the road surface cannot be recognized intuitively. The oppression is felt when the information about the position higher than the road surface cannot be acquired.

In the vehicle periphery monitoring apparatus 1, when the ratio of the three segment areas in the coordinate transformed image is equal to the target ratio, the control portion 6 permits the display portion 4 to display the image screen. According to this configuration, since the bumper position of the host vehicle and the horizontal line position relative to the host vehicle are kept constant in the display image in the vehicle compartment, the vehicle driver feels less discomfort.

In the vehicle periphery monitoring apparatus 1, when the bumper area is smaller than the size based on the target ratio, the control portion 6 composes the image simulating the rear edge portion (the bumper) of the host vehicle with the coordinate transformed image. That is, when the bumper position of the host vehicle is shifted downward relative to a predetermined reference position or when the end edge position is invisible, the image simulating an edge portion of the host vehicle is added in the coordinate transformed image to increase visibility. Accordingly, it may be possible to align the bumper position of the host vehicle with the predetermined reference position.

Therefore, when the display image having a desirably balanced bumper area cannot be acquired by the image correction including the coordinate transformation alone, easy accommodation may be possible to preferably reduce the discomfort of the vehicle driver. In this case, in the positional relationship between the host vehicle and the road surface, the vehicle driver may feel that the bumper position of the host vehicle projects forward or rearward from the actual position. Even when the driver feels the projected position, a safe driving of the host vehicle is promoted (to easily avoid a collision with an obstacle early). This may causes no safety difficulty.

In the vehicle periphery monitoring apparatus 1, when the sky area is smaller than the size based on the target ratio, the control portion 6 composes the image simulating the sky with the coordinate transformed image. In the coordinate transformed image, when the horizontal line position relative to the host vehicle is shifted upward from a predetermined reference position or when the horizontal line position is invisible, the image simulating the sky is added to improve visibility. The horizontal line position relative to the host vehicle can be thereby aligned with the predetermined reference position. Therefore, even when the display image having a desirably balanced sky area cannot be acquired by the image correction including the coordinate transformation alone, easy accommodation may be possible to preferably reduce the oppression of the vehicle driver.

### Other Embodiments

The embodiment of the present disclosure is described. The present disclosure is not limited to the embodiment and can be carried out in various modes without departing from the scope of the present disclosure.

The display portion 4 includes, but is not limited to, a center display of the host vehicle in the vehicle periphery monitoring apparatus 1 of the embodiment. The display portion 4 may include various types of display such as a meter display and a head-up display.

In the vehicle periphery monitoring apparatus 1 of the embodiment, the camera 2 includes, but is not limited to, a rearview camera mounted to the rear of the host vehicle to image the vehicle's periphery including a road surface behind the host vehicle. The camera 2 may include a front view camera mounted to the front of the host vehicle to image the vehicle's periphery including a road surface ahead of the host vehicle.

In the image processing of the embodiment, when the ratio of the segment areas in the coordinate transformed image generated at S150 is equal to the target ratio (S160; YES), the display portion 4 is permitted to display the image screen based on this coordinate transformed image (S170). When the ratio of the segment areas is within a predetermined permissible range based on the target ratio, the image screen based on the coordinate transformed image may be permitted to be displayed on the display portion 4. When the bumper area of the segment areas is equal to or more than the size based on the target ratio and also when the sky area is equal to or more than the size based on the target ratio, the image screen based on the coordinate transformed image may be permitted to be displayed on the display portion 4.

The vehicle periphery monitoring apparatus of the present disclosure includes an image portion, an image processing portion, and a display portion. The image portion is mounted to the host vehicle to image the periphery including a road surface in at least one of the forward and rearward directions of the host vehicle. The display portion displays the image screen based on the coordinate transformed image generated by the image processing portion on the predetermined display area in the vehicle compartment.

In the present disclosure, the image processing portion performs the image correction for the original image captured by the image portion with the parameter. The parameter enables to calculate the end edge position of the host vehicle and the horizontal line position to the host vehicle. The image correction includes the predetermined coordinate transformation, so that the ratio of the three segment areas into which the original image is vertically segmented at the end edge position and horizontal line position becomes close to the predetermined target ratio. According to the image correction, a virtual coordinate transformed image based on the original image is generated.

According to this configuration, when the three segment areas in the coordinate transformed image include the edge area below the edge position, the road surface area between the edge position and the horizontal line position, and the sky area above the horizontal line position, respectively, it may be possible to display the image screen in which the edge area, the road surface area, and the sky area are well balanced by a predetermined ratio.

In the configuration of the present disclosure, the vehicle driver can easily acquire the road condition and the end edge position of the host vehicle and the horizontal line position relative to the host vehicle as the coordinate transformed image on the display portion in the vehicle compartment. The vehicle driver can acquire the positional relationship between the host vehicle and road surface and the information about the height direction instinctively.

According the present disclosure, it may be possible to reduce the discomfort and the oppression felt by the vehicle driver. The discomfort is felt when the positional relation between the host vehicle and road surface cannot be acquired instinctively from the display image in the vehicle compartment. The oppression is felt when information about a higher position than the road surface cannot be acquired from the display image in the vehicle compartment.

The parameter includes the external parameter indicating a positional orientation of the image portion. According to a shape of a vehicle (the host vehicle) mounting the image portion, the image processing portion performs a camera calibration using the parameter to calculate in advance an end edge position of the vehicle and a horizontal line position relative to the host vehicle. When the image portion is mounted to a different type (a model) of vehicle, the information about the end edge position of the host vehicle and the horizontal line position relative to the host vehicle can be calculated in advance.

The present disclosure may be distributed on the market as a program. Specifically, the program functions a computer connected to the image portion and the display portion as the image processing portion.

This program may be installed to one or more computers to acquire the effect equivalent to the effect obtained from the vehicle periphery monitoring apparatus of the present disclosure. The program of the present disclosure may be stored in a ROM and flash memory built in a computer, may be loaded from the ROM and flash memory to the computer, or may be loaded to the computer via a network.

The program may be recorded on any recording mediums readable by computers. The recording mediums include a portable semiconductor memory (a USB memory and a memory card (registered trademark)).

The embodiments and the configuration according to the present disclosure have been illustrated in the above. However, the embodiment, the configuration, and the aspect according to the present disclosure are not restricted to each embodiment, each configuration, and each aspect which have been described above. For example, the embodiment, configuration, and aspect which are obtained by combining suitably the technical part disclosed in different embodiments, configurations, and aspects are also included in the range of the embodiments, configurations, and aspects according to the present disclosure.

1. A vehicle periphery monitoring apparatus comprising:
an image portion that is mounted to a host vehicle and images a periphery including a road surface of at least one of a forward direction and a rearward direction of the host vehicle;
an image processing portion that
subjects an original image captured by the image portion to an image correction including a predetermined coordinate transformation by use of a parameter, causing a ratio of three segment areas of the original image to become close to a predetermined target ratio, wherein an end edge position of the host vehicle and a horizontal line position of the host vehicle are calculated from the parameter, and the original image is vertically segmented at the end edge position and the horizontal line position into the three segment areas, and
generates a virtual coordinate transformed image based on the original image; and
a display portion that displays an image screen on a predetermined display area in a vehicle compartment, based on the coordinate transformed image generated by the image processing portion.

2. The vehicle periphery monitoring apparatus according to claim 1, wherein:
when the ratio of the three segment areas of the coordinate transformed image is equal to the target ratio,
the image processing portion permits the display portion to display the image screen.

3. The vehicle periphery monitoring apparatus according to claim 1, wherein:
the three segment areas of the coordinate transformed image respectively are provided by
an edge area below the end edge position,
a road surface area between the end edge position and the horizontal line position, and
a sky area above the horizontal line position; and
when a ratio of the edge area is less than the target ratio, the image processing portion composes an image simulating an edge portion of the host vehicle with the coordinate transformed image.

4. The vehicle periphery monitoring apparatus according to claim 1, wherein:
the three segment areas of the coordinate transformed image respectively are provided by
an edge area below the end edge position,
a road surface area between the end edge position and the horizontal line position, and
a sky area above the horizontal line position; and
when a ratio of the sky area is less than the target ratio, the image processing portion composes an image simulating a sky with the coordinate transformed image.

5. A program causing a computer to function as the image processing portion according to claim 1, the computer being connected to the image portion and the display portion according to claim 1.

6. A non-transitory computer readable storage medium storing the program according to claim 5.

7. The vehicle periphery monitoring apparatus according to claim 1, wherein:
the horizontal line position indicates a boundary between a sky and a ground in the original image captured by the image portion; and
the end edge position indicates a boundary between the ground and the host vehicle in the original image captured by the image portion.
